(19) United States
(12) Patent Application Publication
(10) Pub. No.: US 2024/0082863 A1
(43) Pub. Date: Mar. 14, 2024

(54) ROBOTICALLY APPLIED 3D-SPRAYABLE EXTERIOR INSULATION AND FINISH SYSTEMS (EIFS) FOR BUILDING ENVELOPE RETROFITS

(71) Applicant: Arizona Board of Regents on Behalf of the University of Arizona, Tucson, AZ (US)

(72) Inventors: Wolfgang Fink, Tucson, AZ (US); Jonathan Bean, Tucson, AZ (US); Brian Adair, Tucson, AZ (US)

(21) Appl. No.: 18/273,102

(22) PCT Filed: Jan. 19, 2022
(86) PCT No.: PCT/US2022/070257

§ 371 Date: Jul. 19, 2023

Related U.S. Application Data
(60) Provisional application No. 63/139,265, filed on Jan. 19, 2021.
(60) Provisional application No. 63/187,861, filed on May 12, 2021.

(51) Int. Cl. B05B 12/08; B05B 12/00; B05B 12/12; B25J 11/00

(52) U.S. Cl. CPC B05B 12/084; B05B 12/004; B05B 12/122; B25J 11/0075

(57) ABSTRACT

Various examples are related to exterior insulation and finish systems (EIFS) for building retrofits. In one example, a method includes sensing, by a robotic system, at least one characteristic of an exterior of a building and, in response to the at least one sensed characteristic, adjusting application of insulation or finish to the exterior by the robotic system. The robotic system can include a 3D-articulated robot or other suitable robot that applies the insulation or finish. The robotic system can include a turret or application head configured to sense the at least one characteristic of the building and apply the insulation or finish to the exterior.

### CROSS REFERENCE TO RELATED APPLICATIONS

This application claims priority to, and the benefit of, co-pending U.S. provisional applications entitled “Robotically Applied 3D-Sprayable Exterior Insulation and Finish Systems (EIFS) for Building Envelope Retrofits” having Ser. No. 63/139,265, filed Jan. 19, 2021, and Ser. No. 63/187,861, filed May 12, 2021, both of which are hereby incorporated by reference in their entireties.

### BACKGROUND

There are 126 million buildings in the United States. These buildings consume 74% of the nation's electricity, are responsible for 35% of its CO2 emissions from energy consumption and use 39% of its total energy. These buildings will remain in operation and continue to contribute significantly to carbon emissions even if all new buildings are made carbon neutral. As such, the Department of Energy (DOE) has identified envelope retrofitting as a major opportunity to significantly reduce the energy and emission footprint of the nation's building infrastructure.

### SUMMARY

Aspects of the present disclosure are related to insulation and finish systems for buildings, such as, e.g., exterior insulation and finish systems (EIFS) for building retrofits. In one aspect, among others, a method comprises sensing, by a robotic system, at least one characteristic of an exterior of a building; and in response to the at least one sensed characteristic, adjusting application of insulation or finish to the exterior by the robotic system. In one or more aspects, the robotic system can comprise a 3D-articulated robot that applies the insulation or finish. The 3D-articulated robot can adjust thickness of the insulation or finish in response to the at least one sensed characteristic. The at least one sensed characteristic can be thickness of the insulation or finish. The at least one sensed characteristic being sensed can comprise one of deviations in building materials, discontinuities in building materials, or thermal or moisture conditions of the exterior of the building.

In various aspects, the method can comprise scanning, by the robotic system, the exterior of the building to obtain information about the at least one sensed characteristic of the exterior of the building; and generating a 3D model of at least a portion of the building based at least in part upon the information, wherein the application of the insulation or finish is based upon the 3D model. The method can further comprise generating a deployment plan based upon the 3D model of the building, wherein the application of the insulation or finish to the exterior of the building by the robotic system is based upon the deployment plan. The method can further comprise identifying obstacles or anomalies in the building based upon the information about the building, wherein the deployment plan is modified based upon the identified obstacles or anomalies. The deployment plan can also take into account user-defined areas to spare or apply insulation and/or finish to. The application of the insulation or finish by the robotic system can be autonomously controlled based upon the deployment plan. The robotic system can be configured to alter the application of the insulation or finish to the exterior of the building in response to real-time sensor feedback. The 3D model can be a 3D point cloud of at least a portion of the building. The information about the building can comprise surface texture or ornamentation of the building. The robotic system can be configured to replicate the surface texture or ornamentation in the insulation or finish. The robotic system can be configured to form user-specified texture or ornamentation in the insulation or finish. The information about the building can be presented to a user through one of a virtual reality (VR) system, an augmented reality (AR) system, or a mixed reality (MR) system based upon the 3D model of the building.

In one or more aspects, the robotic system can comprise an airborne robot that applies the insulation or finish. The robotic system can comprise a scaffold-bound robot, an x-y-z-stage mounted robot, an electrostatic adhesion robot, or a free-climbing robot that applies the insulation or finish. The robotic system can comprise at least one of a proximity sensor or a coating thickness sensor to obtain at least a portion of the at least one sensed characteristic of the exterior of the building. The robotic system can comprise at least one thermal sensor for detection of anomalies in the building. The robotic system can comprise a turret or application head configured to sense at least a portion of the at least one sensed characteristic of the exterior of the building and to apply the insulation or finish to the exterior of the building. The turret or application head can comprise a molding, shaping, or routing tool for finishing the insulation or finish.

In another aspect, a robotic system comprises at least one sensor configured to sense at least one characteristic of an exterior of a building; and at least one nozzle configured to adjust application of insulation or finish to the exterior in response to the at least one sensed characteristic. The robotic system can comprise one or more of the aspects described above. The robotic system can be an autonomous system that can control the application of the insulation or finish to the exterior of the building.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIGS. 1A and 1B illustrate an example of an exterior insulation and finish system (EIFS) with drainage, in accordance with various embodiments of the present disclosure.

FIGS. 2A and 2B illustrate an example of a 3D-articulated robotic system configured for application of EIFS components to a wall or other structure, in accordance with various embodiments of the present disclosure.

FIGS. 3 and 4 are images of examples of airborne robotic systems and climbing or scaling robotic systems, in accordance with various embodiments of the present disclosure.

FIGS. 5A-5L illustrate an example of a wall-EIFS applied by an automated robotic system, in accordance with various embodiments of the present disclosure.

### DETAILED DESCRIPTION

Disclosed herein are various examples related to insulation and finish systems for buildings such as, e.g., exterior insulation and finish systems (EIFS) for building retrofits. Reference will now be made in detail to the description of the embodiments as illustrated in the drawings, wherein like reference numbers indicate like parts throughout the several views. Various systems and methods are presented to facilitate the installation of EIFS. Due to the individualism in how buildings are built (i.e., the shape of the building envelope), envelope retrofitting and the application of EIFS are highly labor-intensive, largely manual processes. Robotic application can facilitate installation of EIFS in three-dimensions (3D). Due to the variations in how buildings are built in different climates, with different materials, and with different sizes and shapes, envelope retrofitting is a highly customized, labor intensive, largely manual process that is difficult to reduce to a one-size-fits-all approach. The application of continuous exterior insulation can significantly increase the thermal performance of existing and new buildings in all US and worldwide climate zones. When applied correctly, continuous exterior insulation works by reducing the effects of thermal bridging in existing wall assemblies and reducing or eliminating the risk of moisture damage from condensation, bulk water leakage, and uncontrolled air movement through the wall assembly. Reducing air leakage, also referred to as increasing airtightness or reducing air infiltration, is another effective strategy to reduce energy usage of existing buildings. Because air is energetically expensive to condition, airtightness measures are especially effective for smaller buildings in extreme climates.

In the US, the low cost of energy often makes energy retrofits economically unpalatable. However, building owners across the commercial and residential sectors regularly invest large sums into improving the aesthetic quality of existing buildings to increase the value of buildings that appear worn or dated, but otherwise retain functional utility.

A largely autonomous, robotically applied, 3D-sprayable EIFS for building envelope retrofits is disclosed that utilizes, e.g., 3D articulated, scaffold-bound, x-y-z-stage mounted, free-climbing, and/or airborne robotic platforms that are sensor equipped to automatically sense and adjust to given envelope shapes and to automatically monitor/control the layer thickness of the exterior insulation. The system is intended to operate largely in an unsupervised fashion and to provide the application of a user-defined thickness of insulation layer for quality purposes.

A robotically applied, 3D-sprayable exterior EIFS can be formed by synergistically combining, e.g., wall-climbing/cliff-scaling robotics and spray-applied exterior insulation and finish, augmented with sensors and controls, e.g., for distance control, obstacle avoidance, and quality-control (e.g., ensuring a consistent thickness of drainage, insulation, base coat, finish, and/or paint layers). Autonomous application of EIFS can increase the thermal performance of existing buildings by providing a new exterior insulation and finish layer that can significantly improve the building thermal performance and airtightness. The EIFS methodology also has the potential to preserve or improve the appearance of existing buildings.

Sensing technologies integrated with the robot and spray application system can allow the system to alter its operation in real-time. The combination of sensing technology and computational algorithms can enable the system controls to alter or stop application patterns in response to situations such as, but not limited to: (1) deviations in materials or material properties, e.g., the system may be configured to apply insulation to brick, but not to wood; (2) the presence of unexpected materials, e.g., a joint repaired with urethane sealant in a building where silicone is present elsewhere; (3) pre-identified obstacles (e.g., windows, balconies, etc.) or newly detected/encountered obstacles during the application of insultation or finish; or (4) differences in thermal or moisture conditions, e.g., the density or thickness of the spray-applied insulation may be increased where increased thermal flux is sensed.

Furthermore, these technologies have the potential to help address in particular a significant roadblock to the preservation of existing masonry buildings, especially those subject to historic preservation protections or where other concerns preclude significant changes in the outward appearance of the building. The methodology can reproduce the visual appearance and texture of substrate surfaces, allowing significant upgrades in building performance without altering the visual character of the building. The same sensing and control technologies can allow for the parametric and precise application of foam, base coat, and finish coat. Automating the application of these components can enable architects and manufacturers to develop new aesthetic expressions for continuous insulation.

Spray Foam Insulation. Spray foam insulation, most commonly spray polyurethane foam or SPF, is a commonly used building construction material. SPF can be either closed-cell, which has a very low permeability to water vapor, or open-cell, which has a relatively higher permeability. Different formulations of foam, including pourable and injectable foams, along with its adhesive properties, make it a versatile product that can function as a sealant, an air barrier, insulation, and/or a moisture control. Common applications include spray foam coating of roof systems and attic spaces, and sealants for exterior walls and around openings. Spray foam installed on surfaces is typically a two-part formulation and is built up on surfaces in lifts of 1-3 inches of thickness. Lifts allow the foam to cure without excessive buildup of heat. The generic name for this category of spray foam is spray-applied two-part bulk foam. Spray foam can be hazardous to human health until it is fully cured. It is typically installed by specialized labor with use of respiratory protection and all skin covered.

Uncured spray foam is also extremely adhesive and forms a durable bond with most common materials, including the materials most commonly used on building facades (e.g., masonry, painted wood, and other cementitious materials). When cured, most formulations of spray foam are rigid to the touch. Spray foam is sometimes used in building retrofits to provide thermally broken anchoring for attachment points, such as metal girts, that would otherwise conduct heat between the building and ambient conditions. For example, spray foam can be used to provide a structural connection between metal frameworks (e.g., girts and wire meshing) and existing walls. When exposed to the elements, spray foam can be coated to protect it from UV degradation. For example, acrylic, silicone, and urethane can be used for different applications. Coatings are typically sprayed on top of the cured foam layer to provide protection. Granules can be added for fire rating, aesthetics, and/or to increase durability.

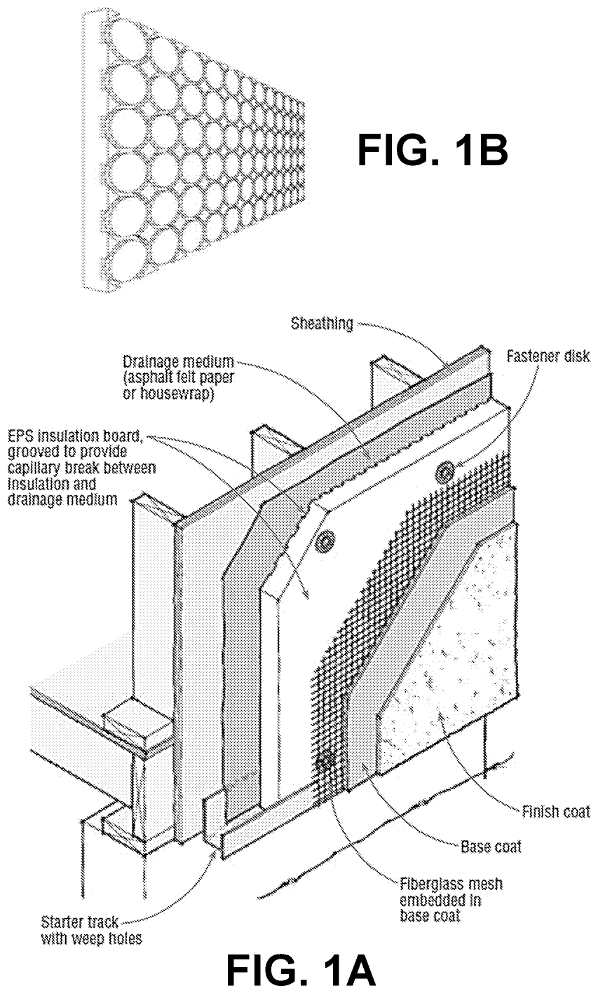

Exterior insulation and finish systems. Exterior insulation and finish systems (EIFS) comprise building products that combine a layer of thermal insulation, typically foam, with a field-applied finish layer. FIG. 1A illustrates an example of an EIFS including a drainage medium, foam layer (EPS insulation board), base coat(s) with embedded fiberglass mesh, and finish coat. The foam layer can be expanded polystyrene (EPS), which is made in a factory and cut to the thickness specified and installed with adhesive, mechanical fasteners (e.g., nails with plastic cap washers), etc. This layer can be mechanically attached or adhered to the building wall. Smaller, specially contoured pieces of foam can be fitted around doors and windows or attached to form architectural ornaments. Gaps between the foam elements can be filled with canned spray foam to form a sealed surface.

Once the building cladding is covered with foam, one or more base coats can be applied. Fiberglass mesh can be embedded in the base coat (or between layers of base coat) to add strength or prevent cracking. The base coat(s) can be followed by one or more finish coats. These coats can be applied with a trowel or with a spray apparatus. The finish coat can have, e.g., a smooth surface or heavy texture. If sprayed, the finish coat can have, e.g., an orange peel or pebbled appearance. EIFS products can be used as barrier claddings. Without a provision for water or moisture to escape, moisture damage can occur making the EIFS prone to failure, especially when applied to wood structures. EIFS systems can integrate drainage at key intersections and interfaces. For example, the back side of the foam panels can be contoured to provide continuous drainage and a path to allow vapor to escape as shown in FIG. 1B. Doors and windows can also be detailed to provide positive drainage.

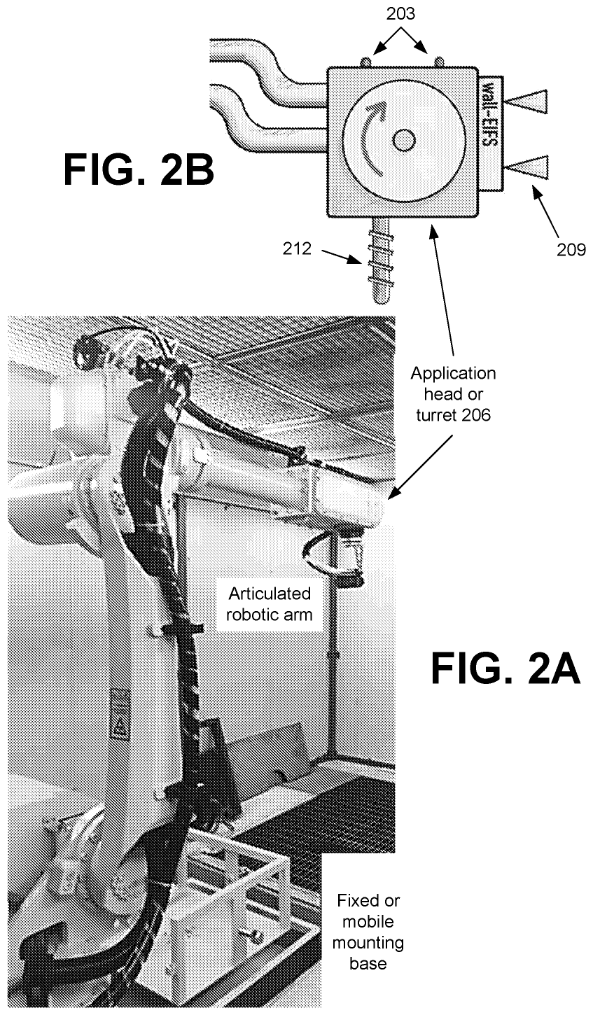

EIFS installation can be automated using, e.g., 3D-articulated spraying, painting and/or coating robotic systems equipped with proximity sensors and coating thickness measuring sensors. FIG. 2A is an image of a 3D-articulated robotic system that can be equipped with proximity sensors (e.g., LIDAR, ultrasound, radar, etc.) and/or thickness measuring sensors (e.g., ultrasound, induction, induction pulse laser, etc.) for measuring the thickness of applied foam coating, insulation, coatings (e.g., base and/or finish), paint, etc. The sensors 203 can be integrated into an application head (or turret) 206 which can be configured to apply the EIFS components to a wall or other structure through application orifices or nozzles 209 as shown in FIG. 2B. The arrangement of sensors 203, nozzles 209, molding/shaping or routing tools 212, or other tools or features on the turret or application head 206 can be varied as needed by the application. For example, all sensors 203, nozzles 209, and molding/shaping or routing tools 212 can be on the same side of the robot or the turret or application head 206.

At its core, EIFS can be applied using an autonomous robot with, e.g., an articulated (e.g., rotating) instrument and sensor equipped turret or application head 206. Other implementations can use different arrangements of sensors 203 and nozzles 209. The entire robot can be mounted on, e.g., on a fully articulated x-y-z stage, a scissor lift with telescopic head, and/or other appropriate fixed or mobile mounting base. For example, the system can be placed on a track parallel to the building wall akin to a scaffold. Other embodiments can be robotic systems that are mounted on, e.g., linear stages, x-y-stages or scaffolds, or x-y-z-stages that can be equipped with proximity sensors (e.g., LIDAR, ultrasound, radar, etc.), non-contacting laser profilometers to assess surface profiles, and/or (coating) thickness measuring sensors (e.g., ultrasound, induction, induction pulse laser, etc.) for measuring the thickness of applied insulation, paint, or coatings. Other implementations can utilize hybrid ground/scaffold-based mounting bases that can facilitate horizontal or vertical movement. The robotic system can also be configured to advance or retract the sensors 203, nozzles 209, molding/shaping or routing tools 212 with respect to the building wall to adjust or control application and/or finishing of the insulation or coating. For example, the turret or application head 206 can be supported by an end-effector of a robotic arm, which can be used to position the sensors 203, nozzles 209, and/or molding/shaping or routing tools 212 as needed.

The application head or turret 206 can be equipped with sensors 203 for wall scanning, e.g., but not limited to, stereo cameras for generating a 3D point cloud of a building wall to be retrofitted, and ultrasound sensors or laser range finders (LIDAR or thermal LIDAR) for precision distance measurements and obstacle avoidance (e.g., balconies and windows, etc.). In addition, the turret or application head 206 can include spray nozzles 209 or other application orifices configured to apply insulation, finish coatings, and/or other materials. The application head 206 can also be equipped with molding, shaping, routing and/or cutting tools 212 to apply or mold/shape custom-designed textures post-retrofit to the building wall by the autonomous robot. In the example of FIG. 2B, the turret or application head 206 can be rotated between sensing by the sensors 203, application through the nozzles or orifices 209, and finishing with the molding, shaping, or routing tool 212.

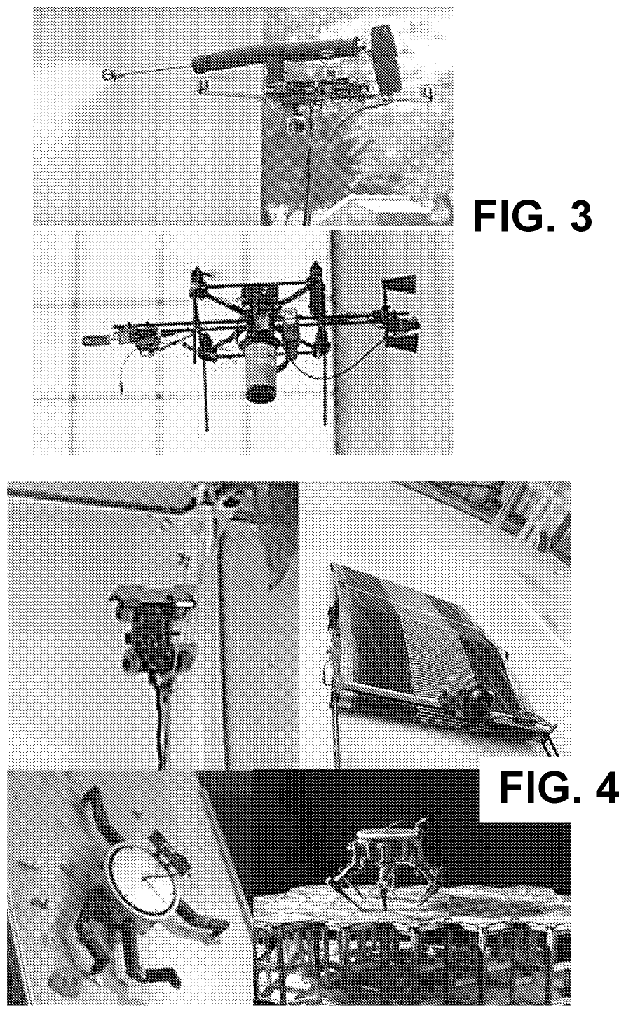

In other embodiments, airborne robotic systems can be employed for application of the EIFS. For example, fully articulated airborne robotic systems such as, but not limited to, helicopters or multi-copters that can be equipped with proximity sensors (e.g., LIDAR, ultrasound, radar, etc.) and/or thickness-measuring sensors (e.g., ultrasound) for measuring the thickness of applied insulation, paint, or coatings. The airborne robotic system can also include other features of the application head 206 such as spray nozzles or molding, shaping, or routing tools. FIG. 3 illustrates examples of multi-copters with a spray head and sensors.

Other robotic systems can include wall-climbing or scaling robots that can support, e.g., a turret or application head 206. The wall-climbing or scaling robot can exploit, e.g., one or more of the following: pressure through suction, e.g., by propellers (i.e., inverse quadcopter principle generating suction instead of lift), electrostatic adhesion, legged suction or drilling, tethered, or other modalities of adhesion/gripping to allow robots to scale/climb building envelopes to sense, administer, mold, shape or route insulation coatings and/or paint. The following table illustrates advantages and disadvantages of various possible adhesion techniques.

| Method Type | Advantage | Disadvantage |
|---|---|---|
| Chemical | Strong bond | Cannot be reused |
| | Can be used on | |
| | multiple surface types | |
| Suction | High force | Poor performance on rough |
| | Low cost | surfaces |
| | | Will not create suction in |
| | | space |
| Synthetic Gecko | Non-damaging/No | Poor performance on rough |
| Feet | residue | surfaces |
| Magnetic | High force capability | Only works on ferromagnetic |
| | | surfaces |
| Mechanical | High force capability | Usually designed for |
| Gripper | Can usually be | specific space bodies or |
| | manipulated | applications |
| Electroadhesion | Repeated use | Relatively lower adhesion |
| | Works on rough and | force |
| | smooth surfaces | Dependent on surface contact |
| | Low cost | area |
| | Space rated materials | |

FIG. 4 illustrates examples of climbing or scaling robots using suction (top left), electrostatic adhesion (top right), and legged suction or drilling (bottom). Electrostatic adhesion can introduce a “stickiness” that can be turned on and off whenever you want to attach to surfaces, particularly also the ones that are not flat. The flexible bits are electrodes that generate alternating positive and negative charges, inducing opposite (i.e., attractive) charges in whatever they are close to, causing them to stick. Electrostatics depend on surface contact to adhere well.

The disclosed robotic systems can be applied to applications beyond building envelope retrofitting for insulation purposes. For example, an autonomous robotic sprayable system can be adapted to apply other finishes besides insulation to buildings, such as stucco, paint, foundation waterproofing, sealant, and other liquids, gels, slurries, and suspensions that can be applied by spraying. Such an autonomous sprayable system can be adapted to apply materials like paints, sealants, and other finishes to structures other than buildings, such as bridges, underpasses/overpasses, tunnels, mines, dams, cell phone towers, transmission and distribution equipment, airframes, vehicle frames (e.g., automotive), ships, submarines, spacecraft, space habitats, underwater habitats, and other large structures upon installation or for periodic maintenance and upkeep. The autonomous sprayable system can also be applied to painting, coating, sculpting, and other processes, e.g., for aircraft fuselages and wings. Moreover, the disclosed technology is applicable to the outside of buildings and to indoor applications, e.g., in the interior of buildings and other volumes.

The disclosed robotic systems can also be applied to form free building technology, which can be applied to new building construction rather than envelop retrofitting of existing building structures. Unlike conventional methods of constructing high mass walls (concrete or otherwise), free form building can reduce the work needed to finish walls because all necessary insulation, electrical conduit and hydronic tubing is IN the wall before it is filled. The process begins with creation of individual wall cells by, e.g., folding and/or bending a roll of heavy wire mesh to a specified length and cut. The cells can then be joined together to form a wall assembly with a specified length, width and height using, e.g., high tensile strength fasteners. The finished lightweight wall assemblies provide the structure for the form free walls. Depending on the climate and/or application need, insulating foam can be inserted into the center of one or more cells of the wall assembly. Electrical conduit and hydronic tubing for radiant heating and cooling can also be attached to and/or integrated with the foam.

With the fabricated wall assemblies at the project site, the wall assemblies can be anchored to the foundation using an appropriate fastening process. Once the wall cell assemblies are anchored to the footings, they can be pumped with, e.g., an earth-friendly soil cement mixture. As the mixture fills the wall cell assembly, it extrudes through the cells where it can be processed to the desired finish. Color can be added to the mixture using oxides before it leaves the concrete batch plant or sprayed on after the walls are finished. The disclosed automated robotic system can be used to, e.g., fill the wall cell assemblies with the cement mixture, finishing the outer surface of the mixture in the wall cell assemblies, and/or applying a coating or coatings over the finished surface of the wall assembly.

The disclosed solution addresses the challenge of adding exterior insulation to particularly wood frame and solid masonry buildings. Existing buildings are notoriously difficult to insulate. Adding insulation to the interior of a wood or metal frame building creates risks for condensation, decay, and mold in the building's enclosure. Interior insulation on masonry buildings can cause moisture to accumulate in bricks, leading to damage from freeze-thaw cycles. In contrast, exterior insulation works in all climates. Moreover, application of interior insulation results in a temporary disturbance to the living of the occupants and/or moving of furniture, wall-mounted pictures, etc. Continuous insulation can deliver significant energy use reductions in both heating and cooling dominated climates. It is of particular benefit to uninsulated masonry buildings, where it not only reduces energy use but also improves occupant comfort. Deployed at scale, wall-EIFS can significantly reduce peak loads, boosting electrification efforts and reducing grid stress related to the deployment of renewables.

The wall-EIFS application is non-invasive because coatings are externally applied. The wall-EIFS can be installed over many types of existing cladding and siding, including fiber-cement, brick veneer, stucco, and on solid masonry walls without requiring demolition or special preparation to the wall surface. Aluminum and vinyl siding may require removal prior to wall-EIFS application. Occupants can remain in the building, with no need to vacate or to move furniture if windows remain in place. Existing windows and doors—or rough openings, if windows and doors are to be replaced—are sheeted and taped to protect from overspray. The increased insulation and improved moisture control can contribute to healthy indoor air quality and improved occupant comfort, in addition to the reduction in energy consumption. The additional insulation can also reduce radiant asymmetry and indirectly reduce drafts from convection currents, while improved air sealing will directly reduce discomfort due to drafts.

These challenges can be met using a robotically applied, 3D-sprayable exterior insulation and finish system for building envelope retrofits. The retrofit can be applied to, e.g., one-to-three story wood-framed and masonry buildings with mostly planar surfaces. Building on an existing prototype comprising two 6-DOF robotic arms mounted on a track, a prototype system can be implemented, e.g., by fitting (or integrating) the robotic arm with sensors 203, nozzles 209, molding/shaping or routing tools 212 and/or an end-effector such as, e.g., a turret or application head 206 (FIGS. 2A and 2B) that can include one or more capabilities for: (a) sensing through, e.g., stereo-cameras for 3D range finding to generate a 3D point cloud of building walls; (b) precision distance measurements through laser range finders (LIDAR or thermal LIDAR) or ultra-sound; (c) coating thickness sensing through induction methods, such as induction pulse lasers; (d) spraying, e.g., through spray nozzles; and/or (e) molding, routing and/or shaping capabilities, e.g., through drill bits of varying size and profile, etc. Sensor-data fusion, image processing and analysis, and path planning algorithms can be employed to generate actionable deployment plans/paths for wall-EIFS and the robotic x-y-z stage (and can also generate information in the form of virtual reality (VR), augmented reality (AR), or mixed reality (MR) visualization for the operator), including obstacle avoidance (e.g., evading balconies and windows, etc.), and when/when not to spray commands. The execution of these plans can be autonomously controlled/supervised through real-time sensor feedback from the turret or application head 206, while manual override by the human operator will always remain an option.

The wall-EIFS can apply rain, air, vapor, and thermal control layers on the outside of the building. This approach works with many common building assemblies constructed with wood or metal framing or masonry units except in the unusual case where a vapor-impermeable layer is already present on the interior side of the wall assembly. The wall-EIFS integrates sensing capabilities—for example, using thermal cameras—that can identify existing faults. These faults can then be mitigated with the application of the new sprayed coating or in a separate process. The wall-EIFS core technology scans, analyzes, maps, and controls the spraying, molding, shaping and/or tooling of insulating and finish materials. Window frames, window glass, and other no-go areas (e.g., vents, decorative features, balconies) can be avoided based on the initial 3D point cloud scanning, placement of control points (e.g., by the human operator), in-situ ad-hoc real-time sensor feedback during the application process, and/or a priori information provided to the robotic system.

Window and door penetrations are the most likely place for water intrusion in wall assemblies. If windows are left in place during the application, wall-EIFS applies the new coating to the existing frame, then verifies the critical seal at the top and sides of the window frame. The wall-EIFS can leave the bottom of the window frame, including the weep holes, open for drainage. A sill pan can be manually installed at the bottom of all existing windows to ensure that bulk water has a path to drip free of the exterior surface of the new coating. If replacement windows are to be installed, wall-EIFS can be used after the old windows are removed to create a thermal break at existing rough openings. In this case, after the new insulation and finish is applied, new windows and/or a sill pan can be installed (e.g., by a crew either from the inside or outside), then integrated with the new control layers to complete the renovation.

Durability is ensured for example with hydrophobic acrylic coating materials. This coating provides the aesthetic appearance, and contributes moisture and UV protection, similar to the finish layer in conventional EIFS construction, roof coatings used in SPF construction, or paint on wood, stucco, or cement siding. EIFS coatings are a proven technology and can last about 50-60 years. The wall-EIFS can also refresh the finish coat to update a building's appearance as tastes change.

An example of the wall-EIFS application using an automated robotic system will now be discussed. For example, the wall can be retrofitted using the autonomous robotic system as follows:
The wall can be scanned and analyzed with a commercial technology such as, e.g., laser range finding (LIDAR) or thermal LiDAR, mounted on the turret or application head 206 (FIG. 2B) to create a 3D point cloud. In some cases, the data can be input or supplemented from a manual survey or as-built drawing. The existing condition and aesthetic appearance of the building can be stored, along with the geometric data, so that a visual representation can be worked with a software platform. Anomalies, such as areas with excess moisture or incompatible sealants, can be identified by the scan so they can be remediated if necessary, e.g., with wall-EIFS's tooling capabilities.
Points can be identified for robotic guidance, navigation, and control (GNC), including window, door frames, edges, and other relevant features to allow wall-EIFS to conform to the building wall and to avoid obstacles and no-go areas.
The automated robotic system can spray insulation material against the wall using the control points to guide application, while avoiding identified obstacles, no-go areas, and wall elements that should not be coated.
The insulation material can be tooled in place to the desired texture and thickness using the reference scan and by applying pattern to simulate an existing cladding material, such as clapboards, stucco, or a novel architectural texture.
Coatings can be spray applied to protect the insulation from UV, add color, and create the surface texture.

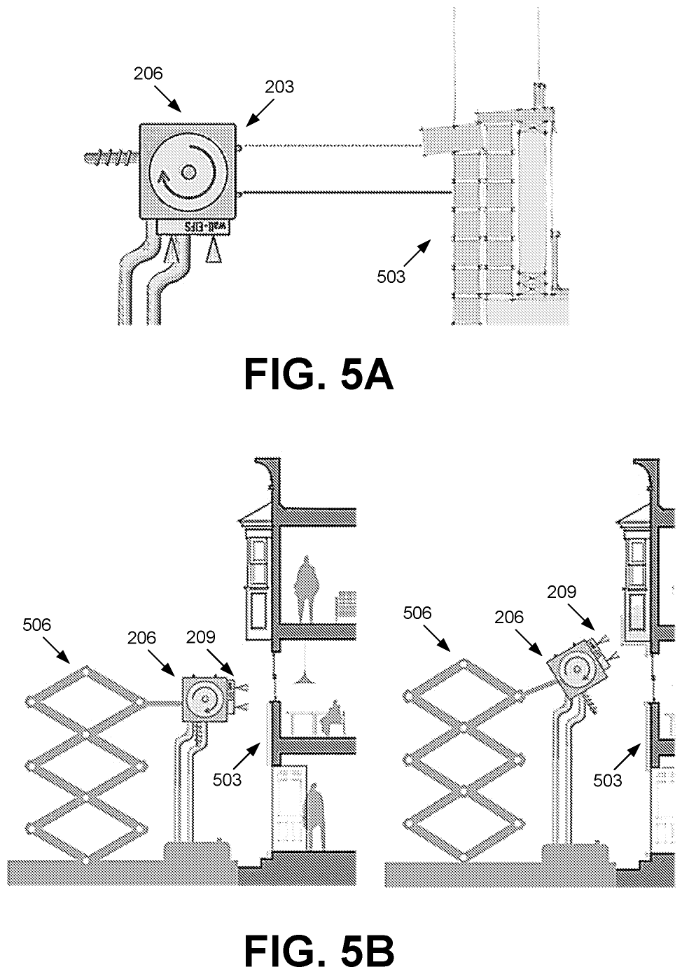

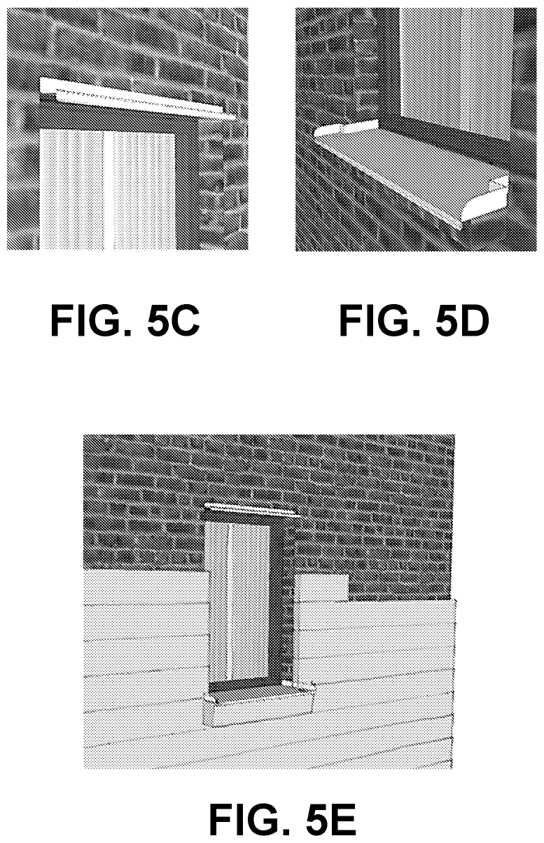

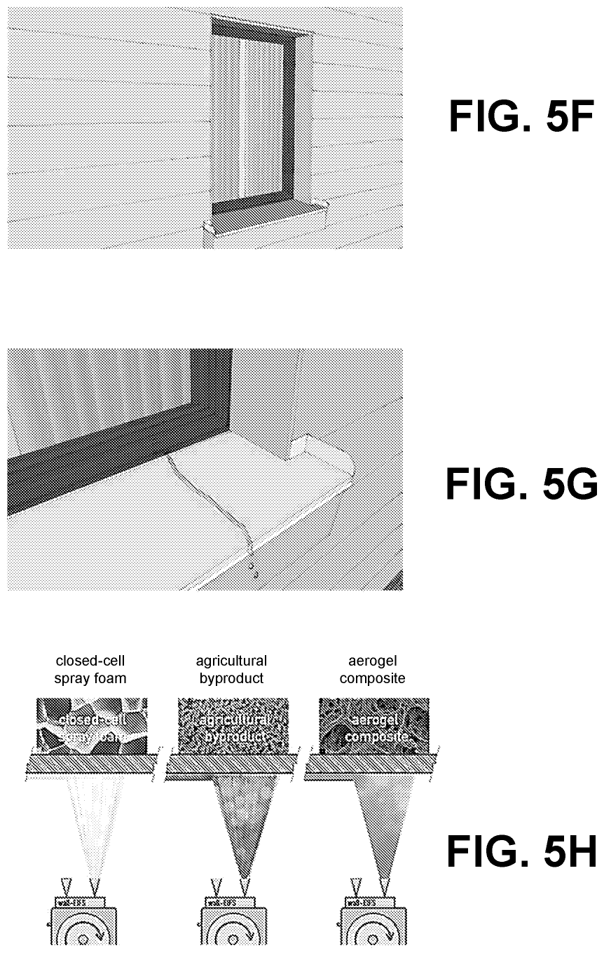

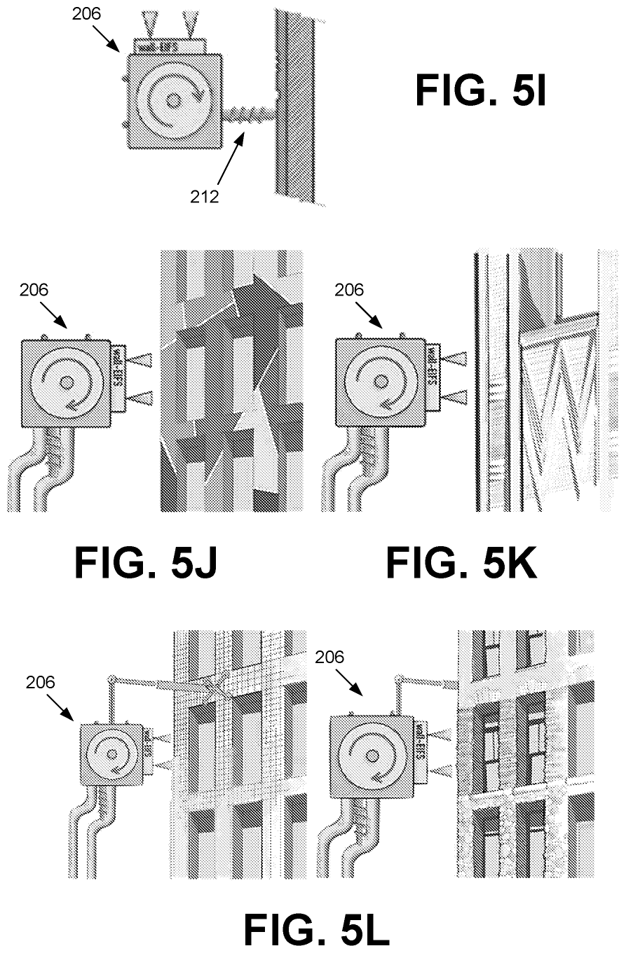

Referring to FIGS. 5A-5L, a detailed description of the wall-EIFS process will be discussed. The solution can include a multi-purpose turret or application head 206 equipped with sensors 203, spray nozzles 209, and a cutting tool 212, as illustrated in FIG. 2B. The turret or application head 206 can be mounted on a robotic scissor lift with telescopic head or on an x-y-z stage, which in turn can ride on a section of lightweight portable track. The track can be installed on site with leveling jacks, parallel to the building wall. The scissor lift with turret or application head 206 can then be placed on the track. This set-up allows the turret or application head 206 full access to the plane of the building wall. It can be compatible of handling a wide range of sprayable insulating materials such as, e.g., two-part spray polyurethane foam made with a low global warming potential blowing agent (e.g., BASF Spraytite®) or other sprayable insulating materials, such as magnesium oxide formulations, clay, agricultural waste, or aerogel composites.

As illustrated in FIG. 5A, in its first pass around the building 503, the turret or application head 206 can use its sensing capabilities to autonomously scan/map and analyze the existing building wall conditions, recording texture and material properties. These data can be used to generate a 3D point cloud of the building wall, which can be used to plan the retrofit strategy and fabricate installation accessories, such as sill pans and drip caps. The turret or application head 206 can also capture data that allow for the identification of problems, such as, but not limited to, accumulated moisture or failing sealant joints with turret-mounted thermal cameras and/or other sensors 203. This information can be fed into a virtual reality (VR), an augmented reality (AR), or a mixed reality (MR) system that an operator can use to monitor and oversee the entire robotic retrofit process.

The compiled information can be used to auto-generate with a computing device (e.g., a laptop, tablet, or other computer) an actionable retrofit plan for wall-EIFS to subsequently execute autonomously. To that end, a deterministic robotic multi-objective path planning algorithm, such as Dijkstra and A*, as well as stochastic variants thereof, can be employed. Digital elevation model (DEM) software can also be utilized to generate a VR, an AR, or MR view of the scanned building walls using the 3D point cloud. Manual override by the human operator remains an option throughout the entire automated retrofit process.

After the actionable retrofit plan has been generated, the turret or application head 206 can be configured to apply or spray durable, insulating materials to the building wall 503. As shown in FIG. 5B, the robotic system can manipulate the turret or application head 206 to apply the insulating materials on portions of the building 503 to be retrofit while avoiding windows or other obstacles and adjusting to anomalies (e.g., checking real-time sensor feedback against the information acquired during the scan). To that effect, the robotic x-y-z stage 506 can be automatically actuated according to the actionable retrofit plan. However, the execution of this retrofit plan can be autonomously controlled/supervised through real-time sensor feedback from the turret or application head 206 throughout the entire process. The operator can have the ability to intervene or respond in real time to the sensed conditions. The wall-EIFS can include one or more of a thermal control layer, a rain control layer, a vapor control layer, and/or an air control layer.

Windows are often replaced when cladding or siding is replaced. In this situation, the windows are removed. The robotically controlled turret or application head 206 can spray material to build up a new sloped sill. It can then spray the new insulating coating to wrap the head and jambs of the masked rough opening. This can prepare a thermally broken rough opening ready for new windows.

When existing windows remain in place, the control layers of the newly applied coating can be made continuous with the tops and sides of the existing windows. To ensure positive drainage and to reduce the risk of moisture accumulation from leakage around and in window frames, a drip cap can be installed (e.g., by a crew working from inside or outside the building) at existing window openings as shown in FIG. 5C before the wall is sprayed. A new sill pan can also be installed as shown in FIG. 5D. A thin aerogel blanket on the underside of the sill pan can improve thermal performance. The sill pan can slide underneath the existing window to provide a path out for any bulk water that makes its way into the window rough opening or frame.

The turret or application head 206 can then be manipulated by the robotic system to spray the insulating coating onto the existing wall surface as shown in FIG. 5E, integrating the new sill pan and drip cap with the new control layers. The insulating coating can be sprayed at the head and each jamb of the window as shown in FIG. 5F, ensuring continuity between the window frame and the critical air and vapor control layers. The automated system does not spray across the bottom of the window as shown in FIG. 5G. This area, including the window's weep holes, is left open to provide a pathway for water drainage to the outermost surface of the new cladding.

The spray nozzles or orifices 209 of the turret or application head 206 can be compatible with sprayable insulating and coating materials such as, but not limited to, closed-cell spray foam, agricultural byproducts, aerogel composites, or other appropriate materials as illustrated in FIG. 5H. The core technology concerns the control of the robotic system and is not tied to a specific material or chemistry.

The turret-mounted integrated molding/routing tool 212 allows post-application molding, shaping, or tooling of the spray-applied material(s) to either replicate existing surface textures, apply a new surface texture or update the look or appearance as shown in FIG. 5I according to the ones that were recorded during scanning to restore the original look of the building. The tooling function allows the robotic system to refine the sprayed surface to produce crisp corners and complex details. The robotic system can also be programmed by building designers to generate custom-designed, new, potentially modernized looks as shown in FIG. 5J. It can responsively and quickly transform dated buildings according to customer-input in the plan-generation phase after the scanning phase. The turret or application head 206 and routing or molding/shaping tool 212 can also iteratively tool coatings applied in layers, allowing for a more convincing representation of open-pore materials such as brick as shown in FIG. 5K. This texture tooling process can be likened to a reverse 3D printing process, such as a drill-mediated ablation process. A computer optimized approach can be applied to plan the tooling operation while optimizing execution time and reduce waste generation. This helps the wall-EIFS to work quickly and efficiently.

The automated robotic system can also be applied using self-scaffolded new construction and seismic retrofits. The combination of a reinforcing mesh and adhesive spray-applied insulating material can add lateral strength to existing masonry buildings. In this case, the application and/or installation of a scaffold can serve simultaneously as the replacement of the x-y-z stage, transforming from a x-y-z stage mounted robot into a free-climbing robot that holds onto each new segment of installed scaffold (e.g., the support can cling to the newly installed scaffold) as the structure is being built as shown in FIG. 5L. As wall-EIFS operates, the scaffold can be encased and contribute to the structural strength of the building. Similar sensing and control frameworks can apply as have been outlined above. Legged, cliff-scaling robots can be applied in this case. Structural, insulative materials can be spray-applied to the scaffolds. All control-aspects during this process would remain the same or would be very similar.

In summary, the robotic wall-EIFS system offers durable insulation and aesthetic flexibility, executed with robotic precision and semi or fully automated. By creating a new system for robotic building retrofit, wall-EIFS can facilitate retrofitting of buildings at scale in a safe (reduced risks from fall and hazardous materials) manner.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

The term “substantially” is meant to permit deviations from the descriptive term that don't negatively impact the intended purpose. Descriptive terms are implicitly understood to be modified by the word substantially, even if the term is not explicitly modified by the word substantially.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include traditional rounding according to significant figures of numerical values. In addition, the phrase “about ‘x’ to ‘y’” includes “about ‘x’ to about ‘y’”.

Therefore, at least the following is claimed:

1. A method for building envelope retrofits, the method comprising:
sensing, by a robotic system, at least one characteristic of an exterior of a building; and
in response to the at least one sensed characteristic, adjusting application of insulation or finish to the exterior by the robotic system.

2. The method of claim 1, wherein the robotic system comprises a 3D-articulated robot that applies the insulation or finish.

3. The method of claim 2, wherein the 3D-articulated robot adjusts thickness of the insulation or finish in response to the at least one sensed characteristic.

4. The method of claim 3, wherein the at least one sensed characteristic is thickness of the insulation or finish.

5. The method of claim 1, wherein the at least one sensed characteristic being sensed comprises one of deviations in building materials, discontinuities in building materials, or thermal or moisture conditions of the exterior of the building.

6. The method of claim 1, comprising:
scanning, by the robotic system, the exterior of the building to obtain information about the at least one sensed characteristic of the exterior of the building; and
generating a 3D model of at least a portion of the building based at least in part upon the information, wherein the application of the insulation or finish is based upon the 3D model.

7. The method of claim 6, further comprising generating a deployment plan based upon the 3D model of the building, wherein the application of the insulation or finish to the exterior of the building by the robotic system is based upon the deployment plan.

8. The method of claim 7, further comprising identifying obstacles or anomalies in the building based upon the information about the building, wherein the deployment plan is modified based upon the identified obstacles or anomalies.

9. The method of claim 7, wherein the application of the insulation or finish by the robotic system is autonomously controlled based upon the deployment plan.

10. The method of claim 9, wherein the robotic system is configured to alter the application of the insulation or finish to the exterior of the building in response to real-time sensor feedback.

11. The method of claim 6, wherein the 3D model is a 3D point cloud of at least a portion of the building.

12. The method of claim 6, wherein the information about the building comprises surface texture or ornamentation of the building.

13. The method of claim 12, wherein the robotic system is configured to replicate the surface texture or ornamentation in the insulation or finish.

14. The method of claim 6, wherein the information about the building is presented to a user through one of a virtual reality (VR) system, an augmented reality (AR) system, or a mixed reality (MR) system based upon the 3D model of the building.

15. The method of claim 1, wherein the robotic system comprises an airborne robot that applies the insulation or finish.

16. The method of claim 1, wherein the robotic system comprises a scaffold-bound robot, an x-y-z-stage mounted robot, an electrostatic adhesion robot, or a free-climbing robot that applies the insulation or finish.

17. The method of claim 1, wherein the robotic system comprises at least one of a proximity sensor or a coating thickness sensor to obtain at least a portion of the at least one sensed characteristic of the exterior of the building.

18. The method of claim 1, wherein the robotic system comprises at least one thermal sensor for detection of anomalies in the building.

19. The method of claim 1, wherein the robotic system comprises a turret or application head configured to sense at least a portion of the at least one sensed characteristic of the exterior of the building and to apply the insulation or finish to the exterior of the building.

20. The method of claim 19, wherein the turret or application head comprises a molding, shaping, or routing tool for finishing the insulation or finish.
